(19) United States
(12) Patent Application Publication
(10) Pub. No.: US 2019/0217975 A1
(43) Pub. Date: Jul. 18, 2019

(54) HARVESTING AND PURIFICATION OF WATER FROM A VEHICLE

(71) Applicant: Ford Global Technologies, LLC, Dearborn, MI (US)

(72) Inventors: John P. CASCI, Westland, MI (US); Courtney L'ARRIVEE, Royal Oak, MI (US); Joshua DIETRICH, Dearborn, MI (US); Scott SCHERAGA, Canton, MI (US); Douglas Raymond MARTIN, Canton, MI (US)

(21) Appl. No.: 15/871,621

(22) Filed: Jan. 15, 2018

(51) Int. Cl. B65B 3/06; B65B 39/00; B60H 1/32; C02F 1/00; B01D 53/26

(52) U.S. Cl. CPC B65B 3/06; B65B 39/00; C02F 2201/008; C02F 1/002; B01D 53/261; B60H 1/3233

(57) ABSTRACT

A gravity-fed system for harvesting and storing clean drinking water in a vehicle is provided. The gravity-fed system includes a heat-exchanger and a reservoir adapted to receive gravity-fed water from the heat-exchanger. The gravity-fed system further includes a bottle receptacle fluidly connected to the reservoir to receive gravity-fed water from the reservoir. The gravity-fed system further includes a filter fluidly connected to and disposed between the reservoir and the bottle receptacle to filter gravity-fed water received from the reservoir.

### TECHNICAL FIELD

This disclosure relates to water harvesting systems integrated in a vehicle, and more specifically to gravity-fed purification of the harvested water.

### BACKGROUND

In many locations, clean drinking water may not be readily available. For example, water may be scarce in arid locations, particularly in some regions where drought is a major recurring problem. The cost of infrastructure to provide clean drinking water in arid locations by traditional underground piping may be prohibitive. One solution has been to use stationary water harvesting stations, such as a water-making billboard, to condense water from the air and make it available for drinking. There exists a need for a water purification system that may provide clean drinking water in a simple cost-effective design.

### SUMMARY

In at least one approach, a gravity-fed system for harvesting and storing clean drinking water in a vehicle is provided. The gravity-fed system may include a heat-exchanger, and a collector adapted to receive gravity-fed water from the heat-exchanger. The gravity-fed system may further include a reservoir adapted to receive gravity-fed water from the collector. The gravity-fed system may further include a filter adapted to receive gravity-fed water from the reservoir. The gravity-fed system may further include a bottle receptacle fluidly connected to the filter through a fill line to receive gravity-fed water from the filter. The bottle receptacle may include a housing defining a cavity for receiving a removable bottle. The bottle receptacle may further include a bottle interface that may be hingedly-connected to the housing. The bottle interface may be fluidly connected at a first side of the interface to the fill line. The bottle interface may define a receptacle at a second side for receiving a bottle nozzle. The gravity-fed system may further include a removable bottle having a bottle nozzle that may be selectively engagable with the receptacle of the bottle interface.

In at least one approach, a gravity-fed system for harvesting and storing clean drinking water in a vehicle is provided. The gravity-fed system may include a heat-exchanger, and a reservoir adapted to receive gravity-fed water from the heat-exchanger. The gravity-fed system may further include a bottle receptacle fluidly connected to the reservoir to receive gravity-fed water from the reservoir. The gravity-fed system may further include a filter fluidly connected to and disposed between the reservoir and the bottle receptacle to filter gravity-fed water received from the reservoir.

In at least one approach, a bottle-attachment system for a vehicle is provided. The bottle-attachment system may include a reservoir adapted to receive water harvested from a heat-exchanger. The bottle-attachment system may further include a bottle receptacle that may be fluidly connected to the reservoir through a fill line. The bottle receptacle may include a housing for receiving a removable bottle, and an interface. The interface may be rotatably-connected to the housing. The interface may also be fluidly connected at a first side to the fill line. The interface may also define a receptacle at a second side for receiving a bottle nozzle.

### BRIEF DESCRIPTION OF THE DRAWINGS

FIG. 1 is a diagrammatic illustration of a first vehicular water harvesting and purification system.

FIG. 2 is a diagrammatic illustration of a second vehicular water harvesting and purification system.

FIG. 3 is a diagrammatic illustration of a bottle attachment and filling system in a first configuration.

FIG. 4 is a diagrammatic illustration of a bottle attachment and filling system in a first configuration.

FIG. 5 is a diagrammatic illustration of a bottle attachment and filling system in a first configuration.

### DETAILED DESCRIPTION

Embodiments of the present disclosure are described herein. It is to be understood, however, that the disclosed embodiments are merely examples and other embodiments may take various and alternative forms. The figures are not necessarily to scale, some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

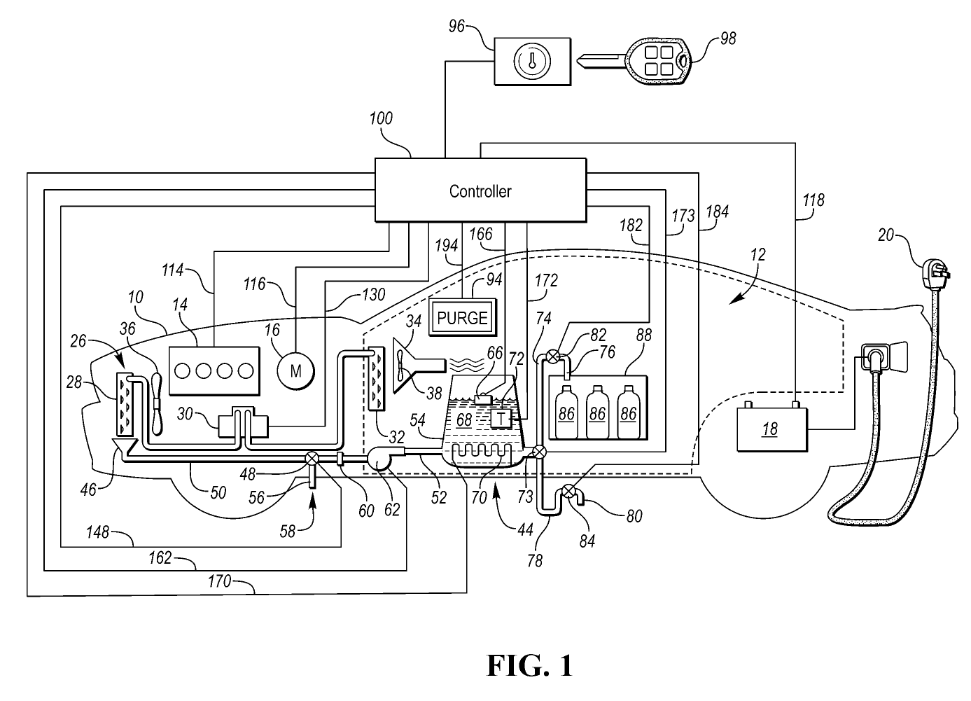

FIG. 1 shows a vehicle 10 having a passenger compartment 12. Vehicle 10 may be a vehicle with an engine 14, an electric machine 16, or both cooperating as a prime mover of the vehicle. The engine 14 and electric machine 16 may represent any machine designed to convert energy into useful mechanical motion. The engine 14 may be a gasoline engine, a diesel engine or any form of an internal combustion engine that burns fuel. The electric machine 16 may be an electric motor. As such, the vehicle may be a traditional engine only vehicle, a battery-only electric vehicle (BEV), or may be a hybrid electric vehicle (HEV).

The vehicle 10 may have a battery 18. The battery 18 may be a high voltage traction battery that, coupled with the electric machine 16, may provide the energy for the electric machine to provide motion.

The vehicle 10 may have a plug-in cable 20. The plug-in cable 20 may be configured to connect the battery 18 to an external power source (not shown). Thus, the battery 18 may be capable of being recharged by plugging the plug-in cable 20 into an external power source.

The vehicle 10 may have an air-conditioning system 26. The air-conditioning system 26 may have a heat-exchanger 28 disposed outside of the passenger compartment 12, a compressor 30, and a heat-exchanger 32 disposed within the passenger compartment 12. The heat exchanger 28 located outside of the passenger compartment 12 may be referred to as a condenser 28. The heat exchanger 32 located within the passenger compartment 12 may be referred to as an evaporator 32. The compressor 30 may be driven by the engine 14, such as by the use of an auxiliary drive belt off a crankshaft (not shown), or an auxiliary drive belt off the electric machine 16, or by having a separate compressor motor (not shown). The compressor motor may be provided energy from the high voltage traction battery 18 or from a 12-volt battery (not shown).

Other components of an air-conditioning system 26 may be present in the system, such as a pressure regulator, an expansion valve, an accumulator, a receiver, a desiccant filter, or the like. The air-conditioning system 26 may also include an electronic control system (not shown) and a series of ducts 34 to route conditioned air from the evaporator 32 into the passenger compartment 12. A fan 36 may be employed adjacent the heat-exchanger 28 to aid in improved airflow across heat-exchanger 28. A second fan 38, or a group of fans 38, may be disposed within the series of ducts 34 to aid in airflow across the heat-exchanger 32.

As a vehicle air-conditioning system 26 runs, water may condense on the heat exchangers 28, 32. Condensation is generally known as a change in the state of water vapor to liquid water when in contact with any surface. Generally when the air-conditioning system 26 is used to cool the passenger compartment, condensation may occur on the heat-exchanger 28 disposed outside of the passenger compartment 12, although condensation may occur on the heat-exchanger 32 located within the passenger compartment as well. The heat-exchanger 28 located outside of the passenger compartment 12 may be in fluid contact with the ambient environment (or an equivalent environment within an engine compartment adjacent the ambient environment. The water that condenses on heat-exchanger 28 may be from water vapor formerly held within air surrounding the heat-exchanger 28.

The vehicle 10 may have a water harvesting and purification system 44. A collector 46 may be located near the heat-exchanger 28 and may be configured to collect condensed water from the heat-exchanger 28. The collector may be located below the heat-exchanger 28 and gravity may be used to collect the water. The collector 46 may be fluidly connected to a collection valve 48 via a collector line 50. The collection valve 48 may be a three-way valve, or a series of T-shaped valves. The collection valve 48 may also be an electric actuated valve 48. The collection valve 48 may be used to divert water from the collector 46 to a first fluid flow path 52 allowing water to flow from the heat-exchanger 28 to a reservoir 54. Said another way, the collection valve 48 may be fluidly disposed between the heat-exchanger 28 and the reservoir 54. Collection valve 48 may also be used to divert water from the collector 46 to a second fluid flow path 56 allowing water to flow from the heat-exchanger 28 to a drain 58 and outside of the vehicle 10.

The first fluid flow path 52 may include a filter 60. The filter 60 may be a mesh screen which may be used for the separation of solids from fluids by interposing a medium through which the fluid can pass but not solids larger than the mesh sizing. The filter 60 may also be a chemical or ultraviolet filtration device which may be used to filter out undesirable bacteria, organic carbons, or the like. The filter 60 may be a number of filters 60. The first fluid flow path 52 may also include a pump 62. The filter 60 may be located before or after the pump 62. The filter 60 may also be located before the collection valve 48. Likewise, the pump 62 may also be located before the collection valve 48. The system may also operate without a filter 60 or pump 62, or provide more than one filter 60 or pump 62 at any location within the harvesting and purification system 44 to provide desired filtration, to move water, or to provide pressure where desired. Thus, the filter 60, if used, may be fluidly disposed between the heat-exchanger 28 and the reservoir 54.

The reservoir 54 may be fluidly connected with the heat-exchanger 28 such that the reservoir 54 is configured to collect water from the heat-exchanger 28. The reservoir 54 may be located inside or outside of the passenger compartment 12. The reservoir 54 may have a water level sensor 66. The water level sensor 66 may be a float 66 disposed within the reservoir 54 which floats on accumulated water 68 within the reservoir 54. The reservoir 54 may have a heating element 70 configured to heat the accumulated water 68. The heating element 70 may be disposed within the water 68, or may be disposed in a wall of the reservoir 54. The accumulated water 68 may also be pre-heated by having the collector line 50 or first fluid flow path 52 warmed by other heat generating sources. For example, the collector line 50 may pass through or near the engine 14.

The reservoir 54 may have a temperature sensor 72 configured to provide a temperature of the accumulated water 68. The temperature sensor 72 may be submerged in the water 68, may be in a wall of the reservoir 54, or may be part of the heating element 70. The heating element 70 may be used to heat the accumulated water 68. The heating element 70 may be used to boil the accumulated water 68. The boiling of the water 68 may be done to remove additional impurities. The air-conditioning system 26 may be used to add heat to the water 68. After heating of the water 68, ducts 34 from the air-conditioning system 26 may be used to cool the water 68. A duct 34 of the multiple ducts 34 may be located proximate the reservoir 54 configured to facilitate cooling of the water 68. Additional cooling devices (not shown) may be used to cool the water 68 after being boiled.

The reservoir 54 may have an outlet valve 73. The outlet valve 73 may be a three way valve similar to the collection valve 48. The outlet valve 73 may be actuated to allow the water 68 to flow out of the reservoir 54. A first dispensing line 74 may extend from the outlet valve 73 to a first spout 76 in the passenger compartment 12. A second dispensing line 78 may extend from the outlet valve 73 to a second spout 80 outside of the passenger compartment 12. The reservoir 54 may be disposed within or outside of the passenger compartment 12. The first spout may be opened and closed by a first dispensing valve 82. The second spout 80 may be opened and closed by a second dispensing valve 84. The first and second valves 82, 84 may be manual valves or electric actuated valves.

The first spout 76 may be configured to fill at least one water bottle 86. The water bottle 86 may be located within a water bottle compartment 88. The water bottle 86 may be a 12-ounce water bottle and the water bottle compartment 88 may be able to hold six water bottles 86. The water bottle compartment 88 may be sized to fit six water bottles 86, three wide and two deep. The first spout 76 may be moveable via a first spout motor (not shown) to fill each water bottle 86. Alternatively, the water bottles 86 may be on a rotatable tray or conveyor tray and each moveable to the first spout 76. The water bottle compartment 88 may be cooled by a duct 34 from the number of ducts 34 of the air-conditioning system 26. The water bottle compartment 88 may also be heated by a duct 34 from the number of ducts 34 of the air-conditioning system 26. The water bottle compartment 88 may be cooled by a separate refrigeration unit (not shown). The water bottle compartment 88 may be disposed in a dash panel or instrument panel adjacent, or in place of, a glove compartment. The system 44 provides a removable bottle 86 with purified water within reach of a driver of the vehicle 10.

The water harvesting and purification system 44 may also have a display 94 for relating information about the water harvesting and purification system 44 to a user. Information may include such data as amount or temperature of the accumulated water 68 in the reservoir 54, whether the accumulated water 68 has been purified, time elapsed since the accumulated water 68 has been purified, or the like. The display 94 may be located in a location visible to a user in the passenger compartment 12. The display 94 may be an existing display in an infotainment system (not shown). The display 94 may be located in a location visible to a user outside of the passenger compartment 12. An exterior display 94 may be within the passenger compartment 12 visible through a window, may be a projector that projects the data onto a window, or may be a series of lights in the exterior surface of the vehicle 10.

An ignition 96 may be connected to the vehicle 10. The ignition 96 may be controlled by a user to key-on and start the vehicle 10. When the vehicle 10 is key-on and started, either the engine 14, motor 16, or both may be used to propel the vehicle 10. As well, in the key-on state, the air-conditioning system 26 may be used to cool the vehicle and provide condensed water for the water harvesting and purification system 44. The user may also use the ignition 96 to key-off and stop the vehicle 10. The engine 14 and motor 16 may not propel the vehicle in a key-off state. A traditional key 98 is shown that may be inserted into the ignition 96 and used to key-on and key-off the vehicle 10, however the ignition may not need an inserted key 98, as it may be a button or have a proximity key, or the like.

The water harvesting and purification system 44 may operate the air-conditioning system 26 to generate condensed water even when the vehicle 10 is in a key-off state. The water harvesting and purification system 44 may operate the air-conditioning system 26 to generate condensed water even when the vehicle 10 has the plug-in cable 20 plugged into an external power source to recharge the battery 18. The water harvesting and purification system 44 may utilize the external power source to provide the energy necessary to operate the air-conditioning system 26 while the vehicle 10 is key-off.

A controller 100 may automate the water harvesting and purification system 44. The controller 100 may be coupled with the engine 14, if one is in the vehicle 10, as indicated by communication line 114. The controller 100 may be coupled with the motor 16, if one is in the vehicle 10, as indicated by communication line 116. The communication lines 114, 116 may communicate data to the controller 100 such as current use of the engine and/or motor 14, 16, among others.

The controller 100 may be coupled with the battery 18, as indicated by communication line 118. The communication line 118 may communicate data such as current state of charge, battery charge level, or whether the battery 18 is being recharged by an external power source (via plug-in cable 20), among others. The controller 100 may be coupled with the compressor 30, as indicated by communication line 130. Communication line 130 may include data about the operation of the air-conditioning system 26, as well as provide a conduit for the controller 100 to control the operation of the compressor 30. The communication line 130 may also convey electrical current from the battery 18 to operate the compressor 30 when the engine 14 or motor 16 are not in use. The controller 100 may be coupled with the air-conditioning system 26, via the compressor 30, and programmed to, in response to the battery 18 being charged by an external electric source, operate the air-conditioning system 26 to generate water from the heat-exchanger 28.

The controller 100 may be coupled with the collection valve 48, as indicated by communication line 148. The controller 100 may be programmed to actuate the control valve 48 to switch from the first fluid flow path 52 to the reservoir 54 or the second fluid flow path 56 to the drain 58. The controller 100 may be programmed to, in response to the water 68 in the reservoir 54 reaching a predetermined level, actuate the control valve 48 to inhibit water flow from the heat-exchanger 28 to the reservoir 54. The controller 100 may be programmed to, in response to the water 68 in the reservoir 54 reaching a predetermined level, switch the collection valve 48 from the first fluid flow path 52 to the second fluid flow path 56. The controller 100 may be programmed to, in response to the water 68 in the reservoir 54 reaching a predetermined level, turn off the air-conditioning system 26 if being run during key-off/plug-in state.

The controller 100 may be coupled with the water level sensor 66, as indicated by communication line 166. The communication line 166 may convey data relating to the level of water 68 in the reservoir 54. The communication line 166 may convey the water 68 in the reservoir 54 reaching a predetermined level. The predetermined level may be different for each programmed operation. The predetermined level may be at least 12 ounces. The predetermined level may be greater than 72 ounces (enough to fill six 12 ounce bottles). The controller 100 may be coupled with the pump 62 via communication line 162. The controller 100 may be programmed to actuate pump 62 to move water or provide pressure within the water harvesting and purification system 44. The controller 100 may utilize the pump 62 to provide the pressure needed for the water 68 to reach the predetermined level.

The controller 100 may be coupled with the heating element 70 via communication line 170. The controller 100 may utilize the heating element 70 to heat the water 68. The controller 100 may utilize the heating element 70 to boil the water 68. The controller 100 may be programmed to, in response to the water 68 in the reservoir 54 reaching a predetermined level, boil the water 68. The controller 100 may be coupled with a temperature sensor 72 via communication line 172. The controller 100 may be programmed to, in response to the water 68 having a temperature indicative of boiling, maintain the temperature of the water for a predetermined period of time. The predetermined time period may be at least one minute. The controller 100 may be further programmed to, in response to the water reaching a predetermined temperature below a temperature indicative of boiling, indicate that the water 68 is ready to drink.

The controller 100 may be coupled with the outlet valve 73 via communication line 173. The controller 100 may actuate the outlet valve 73 to provide water to the first or second fluid flow paths 74, 78, or to maintain water 68 in the reservoir 54 until purified or until at a desired temperature. The controller 100 may be coupled with the first dispensing valve 82 via communication line 182. the controller 100 may be programmed to open the first dispensing valve 82 to automatically fill a water bottle 86. Alternatively, a user may initiate the opening and closing of the first dispensing valve 82 by a touch sensitive button, or the like (not shown).

The controller 100 may be coupled with the second dispensing valve 84 via communication line 184. the controller 100 may be programmed to open the second dispensing valve 84 to automatically purge water from the reservoir. Alternatively, a user may initiate the opening and closing of the second dispensing valve 84 by a touch sensitive button, or the like (not shown). The second dispensing valve 84 in conjunction with the second spout 80 provide an option of filling up any container outside of the vehicle 10.

The controller 100 may be further programmed to purge the water 68 in the reservoir after a second predetermined period of time elapsing from the water having a temperature indicative of boiling. The second predetermined period of time may be at least 12 hours. The controller may be coupled with the display 94 via communication line 194. The controller 100 may be programmed to display information on the display 94. The display 94 may display information relating to the purging of the water 68, such as a countdown until the next purge. The display 94 may also show information relating the amount or temperature of the accumulated water 68 in the reservoir 54, whether the accumulated water 68 has been purified, time elapsed since the accumulated water 68 has been purified, number of water bottles 86 filled, different operating parameters of the system, or the like.

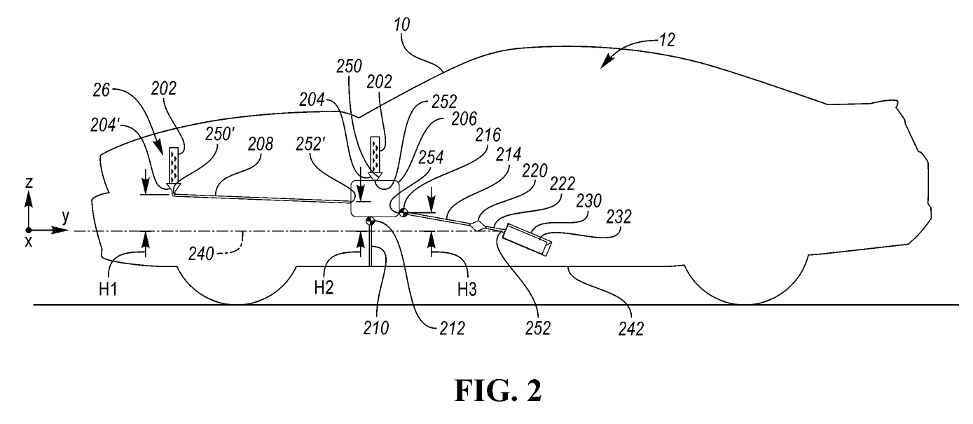

FIG. 2 shows a vehicle 10 having a water harvesting and purification system 200. The vehicle may be the vehicle 10 of FIG. 1. The water harvesting and purification system 200 may be provided in addition to, or instead of, the water harvesting and purification system 44 of FIG. 1. Like reference numerals designate corresponding parts in the drawings and detailed description thereof may be omitted.

The water harvesting and purification system 200 may include a water source. The water source may be, for example, a vehicle component that may generate condensation. In at least one approach, the water source may be associated with an air-conditioning system (which may correspond to the conditioning system 26 of FIG. 1). For example, the water source may be a heat-exchanger 202. In still other approaches, the water source may be a thermoelectric device. In still other approaches, the water source may be a device not associated with an air-conditioning system.

The heat-exchanger 202 may be associated with an air-conditioning system; for example, the air-. In at least one approach, the heat-exchanger 202 may be disposed outside of the passenger compartment 12, and may be referred to as a condenser. In at least another approach, the heat-exchanger 202 may disposed within the passenger compartment 12. and may be referred to as an evaporator. In still another approach, the air-conditioning system may include a heat-exchanger 202 disposed both outside of and within the passenger compartment 12.

As a vehicle air-conditioning system runs, water may condense on the heat-exchanger 202. Condensation is generally known as a change in the state of water vapor to liquid water when in contact with any surface. Generally when the air-conditioning system is used to cool the passenger compartment, condensation may occur on the heat-exchanger 202 disposed outside of the passenger compartment 12, although condensation may occur on the heat-exchanger 202 located within the passenger compartment as well. The heat-exchanger 202 located outside of the passenger compartment 12 may be in fluid contact with the ambient environment (or an equivalent environment within an engine compartment adjacent the ambient environment. The water that condenses on heat-exchanger 202 may be from water vapor formerly held within air surrounding the heat-exchanger 202.

A collector 204 may be located near the heat-exchanger 202 and may be configured to collect condensed water from the heat-exchanger 202. The collector 204 may be located gravitationally below the heat-exchanger 202 and gravity may be used to collect the water.

As used herein, “gravitationally below” and “gravitationally above” may refer to a relative position as acted upon by gravitational forces. In the context of vehicle 10, a first location or component is gravitationally below a second location or component if it is disposed closer along the Z axis to plane 240, which extends in an X-Y plane. The two locations or components may be offset within the X-Y plane and still have a relative position that is gravitationally above/below.

As also used herein, “vertically above” and “vertically below” may refer to different relative positions along the Z axis, but at least partial alignment in the X-Y plane. As such, two components may overlap when viewed in a top down orientation (e.g., along the Z axis).

As will be appreciated, the plane 240 may extend through an inlet 252 of a bottle receptacle 230. Other suitable reference planes are expressly contemplated (e.g., a plane extending through the lowermost surface of the body structure 242 of the vehicle, a plane extending through an uppermost or lowermost region of one or more tires, a plane extending parallel to a ground surface on which the vehicle is disposed, etc.).

The collector 204 may be fluidly connected to a reservoir 206. In at least one approach, the collector 204 may be disposed in direct engagement with the reservoir 206. As such, the collector 204 may be disposed at least partially vertically above the reservoir 206. In at least another approach, the collector 204′ may be fluidly connected to the reservoir 206 through a collector line 208. In at least one approach, the collector line 208 (and other lines described herein) may be a flexible hose or tubing adapted to receive and direct a fluid within the collector line 208. A collection valve may be disposed between the collector 204′ and the reservoir 206.

A drain 210 may be connected (e.g., fluidly connected) to the reservoir 206. The drain 210 may be adapted to divert fluid out of the reservoir 206. For example, the drain 210 may allow water to flow from the reservoir 206 to an outside of the vehicle 10. In this way, the drain 210 may provide an overflow path, and may be referred to as an overflow drain. A valve 212 may be adapted to control flow of fluid through the drain 210. A controller (e.g., controller 100 of FIG. 1) may be adapted to operate the valve 212 (e.g., move the valve 212 between open and closed configurations).

A filter line 214 may be connected (e.g., fluidly connected) to the reservoir 206. The filter line 214 may provide a fluid flow path away from the reservoir 206. In at least one approach, the filter line 214 may include a valve 216 adapted control flow of fluid through the filter line 214. A controller (e.g., controller 100 of FIG. 1) may be adapted to operate the valve 216 (e.g., move the valve 216 between open and closed configurations).

A filter 220 may be disposed along the filter line 214. The filter 220 may include a mesh screen which may be used for the separation of solids from fluids by interposing a medium through which the fluid can pass but not solids larger than the mesh sizing. The filter 220 may also include an ion-exchange filter. The ion-exchange filter may include beads of zeolites and/or activated carbon. The filter 220 may also include a microfiltration filter that may include hollow fibers. The hollow fibers may contain pores less than 0.2 microns across. The filter 220 may also include a chemical filter (e.g., iodine) or an ultraviolet filtration device which may be used to filter out undesirable bacteria, organic carbons, or the like. The filter 220 may be a number of filters 220.

The water harvesting and purification system 200 may include a fill line 222. The fill line 222 may be fluidly connected at one end to the filter 220. The fill line 222 may be fluidly connected at an opposite end to a bottle receptacle 230. In still another approach, the bottle receptacle 230 may be connected to the filter 220. The bottle receptacle 230 may be sized to receive a bottle 232, as discussed in greater detail elsewhere herein.

The components of the water harvesting and purification system 200 may arranged such that gravity directs water collected from the heat-exchanger 202 to the bottle 232. As discussed, the collector 204 may be located below the heat-exchanger 202 and gravity may be used to collect the water at the collector 204.

As shown in FIG. 2, a collector 204 may have an outlet 250 that is disposed gravitationally above an inlet 252 of the bottle receptacle 230. In this way, the heat-exchanger 202, a collector 204, the reservoir 206, the filter 220, and the bottle receptacle 230 may define a fluid flow path that is gravity-driven. The gravity-driven fluid flow path may be adapted to deliver water to the bottle receptacle without the need for a mechanical pump.

In at least one approach, a collector may have an outlet that is disposed gravitationally above an inlet of the reservoir. For example, an outlet 250 that is vertically disposed above an inlet 252 of the reservoir 206 may provide fluid to the reservoir 206. When the collector 204′ is spaced (e.g., longitudinally spaced in the Y direction) form the reservoir 204, the collector 204′ may have an outlet 250′ that may be spaced a first height H1 from plane 240, and an inlet 252′ of the reservoir 206 may be spaced a second height H2 from plane 240 that is less than the first height H1. In this way, gravity may draw fluid from the outlet 250′ of the collector 204 to the inlet 252′ of the reservoir 206.

The reservoir 206 may have an outlet 254 that may be spaced a third height H3 from the plane 240. The third height 240 may be less than either or both of the first and second heights H1, H2.

The filter 220 may be disposed gravitationally between the third height H3 and the plane 240 (i.e., gravitationally between the outlet 254 of the reservoir 206 and the inlet 252 of the bottle receptacle 230.

In this way, H1 may be greater than H2, which may be greater than H3. In this way, gravitation forces may tend to cause fluid to move from heights H1 and H2 to height H3, and subsequently to the inlet 252 of the bottle receptacle 230. More particularly, water may be harvested at heights H1 and/or H2. Gravitational forces may pull the water into the reservoir 206. Gravitational forces may pull the water at height H3 into the filter line 214, through the filter 220, to the bottle receptacle 230, and into a bottle 232 which may be disposed within the bottle receptacle 230.

In at least one approach, the bottle receptacle 230 may be disposed within a center console of the vehicle 10. In still another approach, the bottle receptacle 230 may be disposed within a middle console located between adjacent forward seats of the vehicle 10. In still another approach, the bottle receptacle 230 may be disposed behind a middle console between a row of forward seats and a row of rear seats of the vehicle 10.

In at least one approach, a vehicle 10 may be provided with a plurality of water harvesting and purification systems 200, or a plurality of individual components of the water harvesting and purification system 200 (e.g., multiple reservoirs 206, filters 220, bottle receptacles 230, bottles 232, etc.).

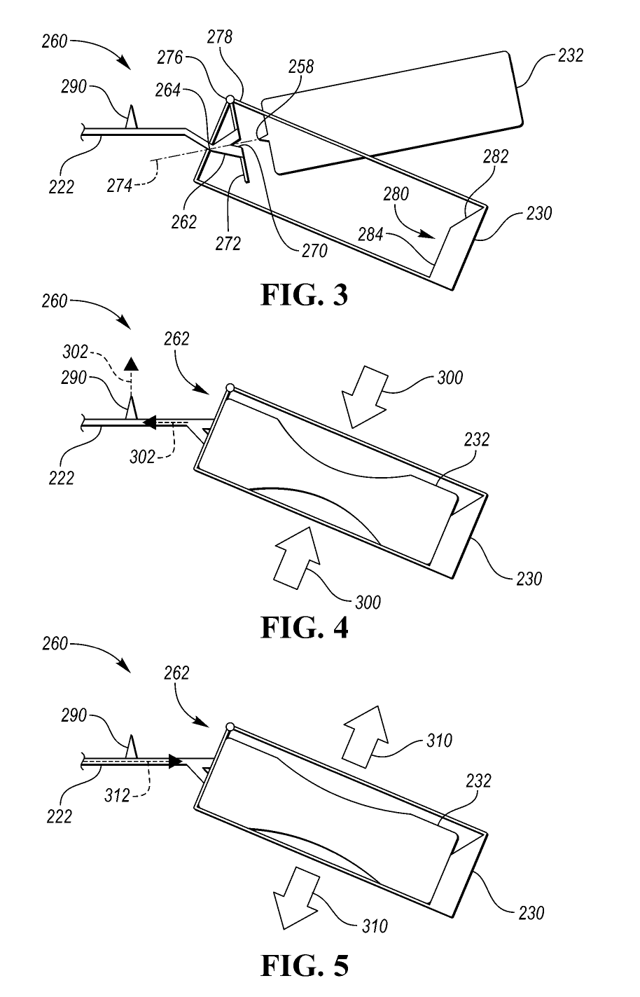

Referring now to FIGS. 3-5, a bottle attachment system 260 may be provided. The bottle attachment system 260 may include a bottle attachment interface 262. The bottle attachment interface 262 may be a coupler adapted to couple the bottle 232 to the fill line 222. For example, the bottle attachment interface 262 may be a dual-valve coupling that may allow for a fluid-tight seal (e.g., 100% sealed) or substantially fluid-tight seal (e.g., 95% sealed) between the bottle 232 and the fill line 222, and may further allow for quick connect and quick disconnect of a bottle 232 from the bottle attachment interface 262. The bottle attachment interface 262 may be formed, for example, of polypropylene or other suitable material.

The bottle attachment interface 262 may be secured to the fill line 222 at a fluid interface 264. The fluid interface 264 may receive the fill line 222 to provide a fluid-tight seal with the fill line 222. For example, the fluid interface 264 may include a ribbed or barbed exterior surface (or interior surface) for receiving and retaining the fill line 222 about an exterior surface (or between an interior surface) of the fluid interface 222. The fluid interface 264 may also, or instead, include a threaded exterior surface (or interior surface) for receiving and retaining the fill line 222 about an exterior surface (or between an interior surface) of the fluid interface 222.

The bottle attachment interface 262 may also be adapted to be secured to a bottle 232. For example, the bottle attachment interface 262 may include a receptacle interface 270 sized and adapted to receive at least a portion of a bottle 232. In at least one approach, the receptacle interface 270 may be formed as a depression within the bottle attachment interface 262. In at least another approach, the receptacle interface 270 may be formed as a protrusion from the bottle attachment interface 262. The receptacle interface 270 may further include one or more seals or o-rings to promote a fluid-tight seal.

The receptacle interface 270 may be sized and adapted to interface with a nozzle 258 of the bottle 232. For example, the receptacle interface 270 may be adapted to engage (or be engaged) in an interference fit configuration with the nozzle 258. In still another approach, the receptacle interface 270 may receive the nozzle 258 in a twist-lock configuration. In this way, at least a partial thread may be formed on either or both of the receptacle interface 270 and the nozzle 258. In this way, the nozzle 258 of the bottle 232 may be secured to the bottle attachment interface 262 at the receptacle interface 270. In at least one approach, the receptacle interface 270 may receive the nozzle 258 to provide a fluid-tight seal with the nozzle 258.

As discussed, the bottle attachment interface 262 may include a shutoff valve that may permit fluid to flow through the bottle attachment interface 262 only a bottle 232 is connected at the receptacle interface 270. When the bottle 232 is disconnected, the shutoff valve may close, blocking flow through the receptacle interface 270.

In at least one approach, the bottle attachment interface 262 may be in the form of a ball-lock coupling. A group of balls may be positioned in holes located around an inner diameter of the receptacle interface 270. These holes may be tapered or stepped to reduce their diameter at the inner diameter of the receptacle interface 270. A spring-loaded sleeve around the outer diameter of the receptacle interface 270 may force the balls toward the inner diameter of the receptacle interface 270. To connect the bottle 232, the sleeve may be pushed back, which opens clearance so the balls may be free to move outward. Once the nozzle 258 of the bottle 232 is in place, the sleeve may be released to forces the ball inward against a locking groove on the outer diameter of the nozzle 258. To disconnect the bottle 232, the sleeve may be pushed back to provide the balls with clearance to move outward and allow the nozzle 258 to be removed.

In still another approach, the bottle attachment interface 262 may be in the form of a roller-lock coupling. In this way, locking rollers or pins may be spaced end-to-end in grooves or slots around the inner diameter of the receptacle interface 270. As the nozzle 258 of the bottle 232 is inserted into the receptacle interface 270, a ramp on the outer diameter of the nozzle 258 may push the rollers outward. Once the nozzle 258 is inserted a prescribed distance, the rollers may slip into a retention groove on the outer diameter of the nozzle 258. Retracting the locking sleeve may allow the ramp on the outer diameter of the nozzle 258 to move the rollers outward, which may allow the nozzle 258 to be released.

In still another approach, the bottle attachment interface 262 may be in the form of a pin-lock coupling. In such an approach, pins may be mounted around an inner diameter of the receptacle interface 270 (e.g., in a truncated-cone-shaped formation). Pushing the plug into the socket may move the pins back and outward; for example, due to a ramp on the plug. Shear across the pins may lock the plug into the receptacle interface 270. Retracting the spring-loaded sleeve may force the pins back out of the locking groove, and as such, may release the nozzle 258 from the receptacle interface 270. Such a configuration may allow push-to-connect joining using only one hand because the receptacle interface 270 may not need to be retracted to make a connection.

In still another approach, the bottle attachment interface 262 may be in the form of a bayonet coupling. In still another approach, the bottle attachment interface 262 may be in the form of a ring-lock coupling. In still another approach, the bottle attachment interface 262 may be in the form of a cam-lock coupling. In still another approach, the bottle attachment interface 262 may be in the form of a multi-tube connector. Other suitable quick-acting couplings are expressly contemplated.

The bottle attachment interface 262 may include a flange 272. The flange may be in the form of a disk having a central aperture that may be aligned with the receptacle interface 270 to permit access to the receptacle interface 270. The flange 272 may be integrally formed with the receptacle interface 270, or may be separately formed and subsequently joined with the receptacle interface 270.

The bottle attachment interface 262 may define a symmetrical receptacle interface 270 and/or a symmetrical flange 272 about a central axis 274 of the bottle attachment interface 262. In this way, a bottle 232 maybe inserted into the bottle attachment interface 262 at any angular rotation of the bottle 232.

The bottle attachment interface 262 may be rotatably attached to a housing 278 of the bottle receptacle 230. In at least one approach, the flange 272 may be rotatably secured to a housing 278 of the bottle receptacle 230 through a hinge pin 276. In at least another approach, the flange 272 may be rotatably secured to a housing 278 of the bottle receptacle 230 through a living hinge. Other suitable approaches for rotatably securing the bottle attachment interface 262 to the housing 278 are expressly contemplated.

In this way, the bottle attachment interface 262 may be rotatable relative to a housing 278 of the bottle receptacle 230. More particularly, the bottle attachment interface 262 may be rotatable between a first angular orientation, shown in FIG. 3, and a second angular orientation, shown in FIGS. 4 and 5. In this first angular orientation, the flange 272 may extend into an internal cavity define by the housing 278 of the bottle receptacle 230. In the second angular orientation, the flange 272 may engage a sidewall of the housing 278 of the bottle receptacle 230. The second angular orientation may be referred to as the “installed” orientation. In the installed orientation, the bottle 232 may be disposed in engagement with the bottle attachment interface 262 at both the receptacle interface 270 and the flange 272, and may be in fluid-tight engagement with the fill line 222.

The bottle receptacle 230 may further include a guide wall 280. The guide wall 280 may define a sloped surface 282 and an abutment surface 284. The abutment surface 284 may be disposed in a plane extending at a non-zero angle (e.g., oblique angle) relative to a plane through which the abutment surface 284 extends. In this way, the guide wall 280 may provide assistance during installation of the bottle 232 within the bottle receptacle 230.

To install the bottle 232 within the bottle receptacle 230, a user may secure the bottle 232 with the bottle attachment interface 262, for example, by engaging the nozzle 258 of the bottle 232 with the receptacle interface 270 of the bottle attachment interface 262. The user may then rotate the bottle 232 into the housing 278 of the bottle receptacle 230. A bottom portion of the bottle 232 may slide along the sloped surface 282 of the guide wall 280 and into the bottle receptacle 230.

The water harvesting and purification system 200 may further include a valve 290. The valve 290 may be a one-way valve and may be disposed on the fill line 222 downstream of the filter 220. The valve 290 may assist in filling the bottle 232 with fluid; e.g., water stored in the reservoir 206 of FIG. 2.

In at least one approach, the bottle 232 may be a removable bottle in the form of a user-squeezable bottle. In this way, the bottle 232 may be formed of a resilient, flexible material. As such, the bottle 232 may be adapted to be compressed from a relaxed configuration to a compressed configuration, and may be relaxed from the compressed configuration to the relaxed configuration. In this way, the bottle 232 may be compressible such that fluid content (e.g., air) within the bottle 232 may be expelled upon compression.

As shown in FIG. 4, a user may expel fluid (e.g., air) from the bottle 232 by squeezing the bottle, as indicated by arrows 300. By squeezing the bottle 232, air may be expelled into the fill line 222 and through the valve 290, as indicated by arrows 302.

As shown in FIG. 5, after squeezing the bottle 232, a user may draw fluid (e.g., water) into the bottle 232 by releasing the squeezing force on the bottle, as indicated by arrows 310. By releasing the squeezing force on the bottle 232, a vacuum may be created. The vacuum may draw water from the reservoir 206 into the bottle 232, as indicated by arrow 312. As the valve 290 may be a one-way valve, the valve 290 may inhibit air from being drawn into the fill line 222. In this way, the bottle 232 may be substantially filled with water from the reservoir 206. In this way, when the bottle 232 is engaged with the receptacle interface 270 of the bottle attachment interface 262, the one-way valve 290 may be adapted to expel air from the fill line 222 when the bottle 232 compresses from the relaxed configuration to the compressed configuration, and may be adapted to inhibit airflow into the fill line 222 in when the bottle 232 relaxes from the compressed configuration to the relaxed configuration.

While exemplary embodiments are described above, it is not intended that these embodiments describe all possible forms encompassed by the claims. The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A gravity-fed system for harvesting and storing clean drinking water in a vehicle comprising:
a heat-exchanger;
a collector adapted to receive gravity-fed water from the heat-exchanger;
a reservoir adapted to receive gravity-fed water from the collector;
a filter adapted to receive gravity-fed water from the reservoir;
a bottle receptacle fluidly connected to the filter through a fill line to receive gravity-fed water from the filter, the bottle receptacle including a housing defining a cavity for receiving a removable bottle, and a bottle interface that is hingedly-connected to the housing, wherein the bottle interface is fluidly connected at a first side of the interface to the fill line, and wherein the interface defines a receptacle at a second side for receiving a bottle nozzle; and
a removable bottle having a bottle nozzle that is selectively engagable with the receptacle of the bottle interface.

2. The gravity-fed system of claim 1 wherein the removable bottle is a compressible removable bottle adapted to be compressed from a relaxed configuration to a compressed configuration, and to be relaxed from the compressed configuration to the relaxed configuration.

3. The gravity-fed system of claim 2 further comprising a one-way valve disposed within the fill line.

4. The gravity-fed system of claim 3 wherein when the removable bottle is engaged with the receptacle of the bottle interface, the one-way valve is adapted to expel air from the fill line when the compressible removable bottle compresses from the relaxed configuration to the compressed configuration.

5. The gravity-fed system of claim 4 wherein the one-way valve is adapted to inhibit airflow into the fill line in when the compressible removable bottle relaxes from the compressed configuration to the relaxed configuration.

6. A gravity-fed system for harvesting and storing clean drinking water in a vehicle comprising:
a heat-exchanger;
a reservoir adapted to receive gravity-fed water from the heat-exchanger;
a bottle receptacle fluidly connected to the reservoir to receive gravity-fed water from the reservoir; and
a filter fluidly connected to and disposed between the reservoir and the bottle receptacle to filter gravity-fed water received from the reservoir.

7. The gravity-fed system of claim 6 further comprising a collector disposed below the heat-exchanger to receive gravity-fed water from the heat-exchanger.

8. The gravity-fed system of claim 7 wherein an outlet of the collector is spaced a first height H1 from a plane extending through inlet of the bottle receptacle and normal to a gravitational force, wherein an inlet of the reservoir is spaced a second height H2 from the plane, wherein an outlet of the reservoir is spaced a third height H3 from the plane, and wherein H1>H2>H3.

9. The gravity-fed system of claim 7 wherein the heat-exchanger, the collector the reservoir, the filter, and the bottle receptacle define a fluid flow path that is gravity-driven and does not include a mechanical pump.

10. The gravity-fed system of claim 7 further comprising a collector line secured at one end to an outlet of the collector and at an opposite end to an inlet of the reservoir, wherein the inlet of the reservoir is disposed below the outlet of the collector to receive gravity-fed water from the collector.

11. The gravity-fed system of claim 10 further comprising a filter line secured at one end to an outlet of the reservoir and at an opposite end to an inlet of the filter, wherein the inlet of the filter is disposed below the outlet of the reservoir to receive gravity-fed water from the reservoir.

12. The gravity-fed system of claim 11 further comprising a fill line secured at one end to an outlet of the filter and at an opposite end to an inlet of the bottle receptacle, wherein the inlet of the bottle receptacle is disposed below the outlet of the filter to receive gravity-fed water from the filter.

13. The gravity-fed system of claim 12 further comprising a removable bottle disposed within the bottle receptacle and fluidly connected to the fill line to receive gravity-fed water from the fill line.

14. A bottle-attachment system for a vehicle comprising:
a reservoir adapted to receive water harvested from a heat-exchanger; and
a bottle receptacle fluidly connected to the reservoir through a fill line, the bottle receptacle including a housing for receiving a removable bottle, and an interface that is rotatably-connected to the housing, fluidly connected at a first side to the fill line, and that defines a receptacle at a second side for receiving a bottle nozzle.

15. The bottle-attachment system of claim 14 wherein the interface includes a flange rotatably-connected to the housing, and wherein the flange extends symmetrically about a central axis of the receptacle.

16. The bottle-attachment system of claim 15 wherein the interface is rotatable between a first angular orientation in which the flange extends into an internal cavity defined by the housing, and a second angular orientation in which the flange engages a sidewall of the housing.

17. The bottle-attachment system of claim 16 wherein the interface is adapted to provide a substantially fluid-tight seal between the fill line and an interior cavity of the removable bottle when a bottle nozzle of the removable bottle is received within the receptacle.

18. The bottle-attachment system of claim 17 wherein the housing is adapted to support the removable bottle in an inclined orientation when the removable bottle is disposed within the internal cavity of the housing.

19. The bottle-attachment system of claim 14 further comprising a one-way valve disposed within the fill line.

20. The bottle-attachment system of claim 19 wherein the one-way valve is adapted to expel air from the fill line when the removable bottle compresses from a relaxed configuration to a compressed configuration, and to inhibit airflow into the fill line when the removable bottle relaxes from the compressed configuration to the relaxed configuration.
